(19) United States
(12) Patent Application Publication
(10) Pub. No.: US 2025/0219418 A1
(43) Pub. Date: Jul. 3, 2025

(54) GRID-FORMING INVERTER WITH IMPROVED RESPONSE SPEED AND CONTROL METHOD THEREOF

(71) Applicant: KOREA INSTITUTE OF ENERGY RESEARCH, Daejeon (KR)

(72) Inventors: Jae Young PARK, Daejeon (KR); Sea Seung Oh, Daejeon (KR); Suk In Park, Daejeon (KR); Mo Se Kang, Daejeon (KR); Hye Jin Kim, Sejong-si (KR)

(73) Assignee: KOREA INSTITUTE OF ENERGY RESEARCH, Daejeon (KR)

(21) Appl. No.: 19/006,708

(22) Filed: Dec. 31, 2024

(30) Foreign Application Priority Data
Jan. 3, 2024 (KR) 10-2024-0000642

(51) Int. Cl. H02J 3/14; H02J 3/38; H02M 7/5395

(52) U.S. Cl. CPC H02J 3/14; H02J 3/381; H02M 7/5395; H02J 2300/24; H02J 2300/28

(57) ABSTRACT

A grid-forming inverter comprises: a power stage configured to convert electric power according to on/off controls of switching devices and to output converted electric power to a grid; and a control circuit configured to calculate a first phase control value using an inertia model that integrates a difference between a power command value and an active output power value of the power stage, to calculate a second phase control value through feed-forward control that additionally reflects the power command value in the first phase control value, and to control the switching devices using pulse width modulation (PWM) according to the second phase control value.

### CROSS REFERENCE TO RELATED APPLICATION

This application claims the benefit of and priority to Korea Patent Application No. 10-2024-0000642, filed on Jan. 3, 2024, the entire disclosure of which is hereby incorporated herein by reference in its entirety.

### FIELD OF TECHNOLOGY

The present disclosure relates to a grid-forming inverter.

### BACKGROUND

Inverters to convert electric energy generated by renewable energy sources into electric power having a form suitable for a grid are developed in a form of a grid-following inverter.

A grid-following inverter is controlled to conform with voltages, frequencies, and phases of a grid.

A grid-following inverter has a relatively simple configuration, and thus, its installation and operation may be easy. Accordingly, its maintenance costs may be low and its reliability may be high.

Since a grid-following inverter may automatically synchronize with a grid in its voltages, frequencies, and phases, it can easily be connected to the grid and its load on the grid may be minimized.

For a developer who needs to mount an inverter to a renewable energy source, installing a grid-following inverter would be more advantageous either in terms of costs or in terms of operations.

However, in terms of managing a grid, a grid-following inverter has various elements of load.

Traditional synchronous generators have inertia because of their structural characteristics, which is an important element for stability of a grid. The inertia of a synchronous generator comes from its rotating part, in particular, a large turbine and a rotor of the generator. Such inertia helps a grid maintain voltages and frequencies stable within a predetermined range in short-term variability situations generated in a grid, for example, in situations of a sudden increase or decrease of load in a grid.

A grid-following inverter does not provide such inertia to a grid. A grid-following inverter may rather be an element that deteriorates the inertia of a grid due to its characteristic of following voltages and frequencies of a grid. Such a characteristic of a grid-following inverter may be a burden for the management of a grid.

In a case when sufficiently numerous synchronous generators are connected to a grid, there would not be a big problem even if multiple grid-following inverters are connected to the grid. However, since the proportion of generation by renewable energy sources increases and the proportion of generation by synchronous generators relatively decreases, the characteristic of grid-following inverters may emerge as a serious problem in terms of management of a grid.

The discussions in this section are intended merely to provide background information and do not constitute an admission of prior art.

### SUMMARY

An aspect of the present disclosure is to provide a technology regarding a grid-forming inverter that contributes to the frequency stability of a grid. Another aspect of the present disclosure is to provide a technology for improving slow responsiveness of a grid-forming inverter. Still another aspect of the present disclosure is to provide a technology for improving the response speed of a grid-forming inverter controlled by a virtual synchronizer. Still another aspect of the present disclosure is to provide a technology for improving the frequency nadir through rapid responses to electric power commands.

According to an embodiment, a grid-forming inverter is provided. The grid-forming inverter comprises: a power stage configured to convert electric power according to on/off controls of switching devices and to output converted electric power to a grid; and a control circuit configured to calculate a first phase control value using an inertia model that integrates a difference between a power command value and an active output power value of the power stage, to calculate a second phase control value through feed-forward control that additionally reflects the power command value in the first phase control value, and to control the switching devices using pulse width modulation (PWM) according to the second phase control value.

The control circuit may apply a first transfer function to the power command value before performing feed-forward control that additionally applies the power command value to the first phase control value.

A bandwidth of the first transfer function may be narrower than a bandwidth of a voltage controller disposed between the second phase control value and an output of a PWM signal.

The bandwidth of the first transfer function may fall within a certain range of 1/10 of the bandwidth of the voltage controller.

The control circuit may calculate an angular velocity control value by subtracting the active output power value of the power stage and a damping value from the power command value, dividing a result value by a predetermined inertial value, and integrating a result value; and calculate the first phase control value by multiplying the angular control value by a certain coefficient and integrating a result value.

The control circuit may calculate the damping value by multiplying a difference between the angular velocity control value and an angular velocity value of a gride voltage by a damping coefficient.

The angular velocity value of the grid voltage may be measured by a phase lock loop (PLL) circuit.

The control circuit may calculate the second phase control value by multiplying the power command value by a feed-forward gain and adding up a result value to the first phase control value.

The feed-forward gain may be determined in response to a reciprocal of the maximum output of the power stage.

A value of the maximum output may be determined by a value obtained by dividing three times a nominal voltage by a reactance.

According to another embodiment, a method for controlling a power stage in which a grid-forming inverter converts electric power according to on/off controls of switching devices and outputs converted electric power to a grid is provided. The method comprises operations or steps of: calculating a first phase control value using an inertia model that integrates a difference between a power command value and an active output power value of the power stage and calculating a second phase control value through feed-forward control that additionally reflects the power command value in the first phase control value; and performing pulse width modulation (PWM) control with respect to the switching devices based on the second phase control value.

In the operation or step of calculating the second phase control value of the method, a first transfer function may be applied to the power command value before performing the feed-forward control that additionally reflects the power command value in the first phase control value.

A bandwidth of the first transfer function may be narrower than a bandwidth of a voltage controller disposed between the second phase control value and an output of a PWM signal.

In the operation or step of calculating the second phase control value, the method may include calculating an angular velocity control value by subtracting the active output power value of the power stage and a damping value from the power command value, dividing a result value by a predetermined inertia value, and integrating a result value; and calculating the first phase control value by multiplying the angular velocity control value by a certain coefficient and integrating a result value.

In the operation or step of calculating the second phase control value, the method may include calculating the second phase control value by multiplying the power command value by a feed-forward gain and adding up a result value to the first phase control value.

As described above, the present disclosure may provide a technology regarding a grid-forming inverter that contributes to the frequency stability of a grid. The present disclosure may provide a technology for improving slow responsiveness of a grid-forming inverter. In addition, the present disclosure may provide a technology for improving the response speed of a grid-forming inverter controlled by a virtual synchronizer. Further, the present disclosure may provide a technology for improving the frequency nadir through rapid responses to electric power commands.

### BRIEF DESCRIPTION OF THE DRAWINGS

In order that the disclosure may be well understood, there are now described various

forms thereof, given by way of example, reference being made to the accompanying drawings, in which:

FIG. 1 is a configuration diagram of a general power system;

FIG. 2 is a configuration diagram of a power system according to an embodiment;

FIG. 3 is a configuration diagram of a grid-forming inverter according to an embodiment;

FIG. 4 is a configuration diagram of a control circuit according to an embodiment;

FIG. 5 is a diagram showing a first example of a phase control circuit according to an embodiment;

FIG. 6 is a diagram showing a second example of a phase control circuit according to an embodiment;

FIG. 7 is a diagram showing a third example of a phase control circuit according to an embodiment;

FIG. 8 is a diagram showing waveforms of output power in a simulation of a grid-forming inverter according to an embodiment;

FIG. 9 is a diagram showing waveforms of frequencies in a simulation of a grid-forming inverter according to an embodiment; and

FIG. 10 is a flow diagram of a grid-forming inverter control method according to an embodiment.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only to distinguish a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

When a component, device, module, element, or the like of the present disclosure is described as having a purpose or performing an operation, function, or the like, the component, device, or element should be considered herein as being “configured to” meet that purpose or perform that operation or function.

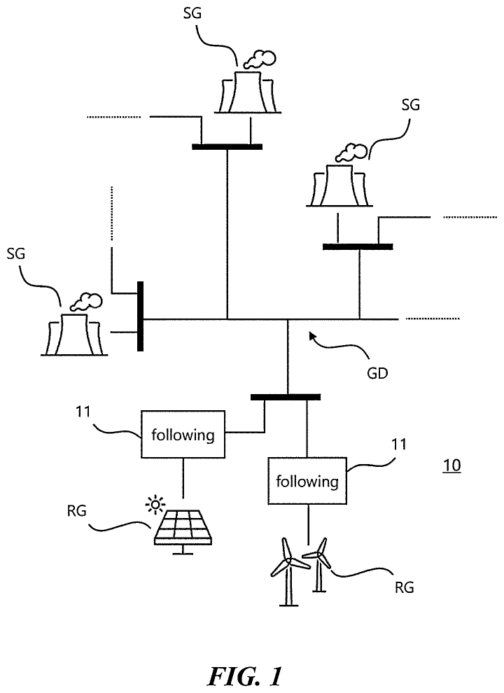

FIG. 1 is a configuration diagram of a general power system.

Referring to FIG. 1, a grid GD may be formed in a power system 10.

The grid GD may be a large-scale electrical grid to which numerous synchronous generators SG are connected. Synchronous generators may include, for example, hydroelectric generators, thermal power generators, nuclear power generators, etc. In a hydroelectric generator, large turbines rotate using water flows of rivers or dams and such rotations of large turbines may generate inertia. A thermal power generator generates electric power by boiling water using combustion by fossil fuels, such as coal, natural gas, or petroleum and rotating turbines using steam generated in this way. In a thermal power generator as well like in a hydroelectric generator, the rotation of turbines may generate inertia. In a nuclear power generator as well, turbines rotate using nuclear power and inertia is generated from this process.

In the general power system 10, the proportion of power generation of synchronous generators SG is overwhelmingly high. Accordingly, the grid GD may stably operate using inertia of the synchronous generators SG.

The general power system 10 may include renewable energy generators (RG) such as photovoltaic power generators and/or wind power generators. Electric power generated by the renewable energy generators RG may not be in a form suitable for the grid GD. For example, electric power generated by a photovoltaic power generator is in a form of direct current voltages, and thus, it cannot be directly inputted into the grid GD, which uses power in a form of alternating current voltages. In case of the wind power generators, since the frequencies or the level of voltages of generated power are different from the frequencies or the voltage level of power used for the grid GD, power generated by the wind power generators cannot be directly inputted into the grid GD.

Accordingly, electric power generated by the renewable energy generators RG may be inputted into the grid GD after it is converted using inverters 11.

The renewable energy generators RG connected to the general power system 10 supply power to the grid GD after converting power mainly using grid-following inverters 11.

The grid-following inverters 11 may be automatically synchronized with the grid GD in terms of voltages, frequencies, and phases, and this leads to an easy connection to the grid GD. The grid-following inverters serve to stably supply to the grid power generated by energy sources having high variability, such as energy sources using photovoltaic power or wind power. Design of a grid-following inverter 11 is relatively simple, and thus, its installation and operation are easy. In addition, this leads to advantages of low maintenance costs and high reliability. In the process of being connected with the grid GD, the grid-following inverter 11 constantly senses states of the grid GD and adjusts output as necessary.

However, in a case when the grid GD is unstable or cannot be used, the grid-following inverters 11 may be stopped operating. This means that, in a situation that the grid GD is stopped operating or malfunctions, the grid-following inverters 11 cannot supply power to the grid GD. The grid-following inverters 11 may have trouble in adapting to the variability of the grid GD and this may affect the stability of the grid GD in combination with a high variability of the renewable energy generators RG.

In response to climate change and in preparation for the exhaustion of fossil fuels, synchronous generators are rapidly replaced with renewable energy generators. When the proportion of synchronous generators SG is reduced and the proportion of renewable energy generators RG increases, sources to supply inertia to the grid GD are also reduced. When the inertia in the grid GD is reduced, the variability in voltages and frequencies increases, even worse, there could be an accident that the grid GD breaks down even by a small change.

In order to deal with the rapid conversion into renewable energy generators RG, researches on using grid-forming inverters instead of grid-following inverters appear.

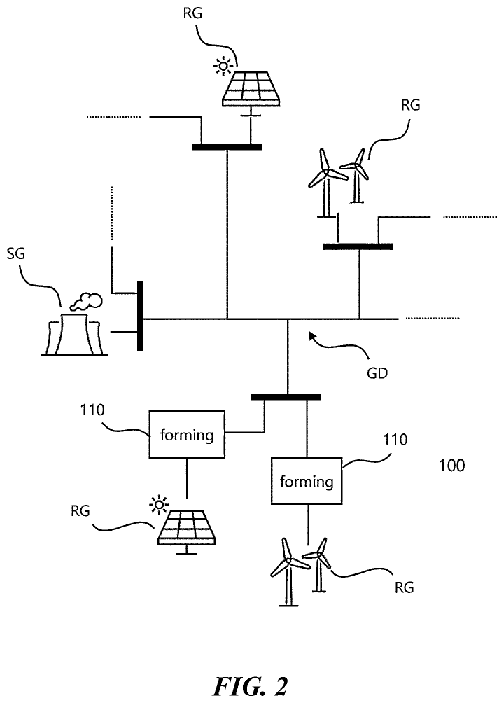

FIG. 2 is a configuration diagram of a power system according to an embodiment.

Referring to FIG. 2, a grid GD may be formed in a power system 100 and multiple renewable energy generators RG may be connected to the grid GD. Such renewable energy generators RG may supply generated power to the grid GD through grid-forming inverters 110.

The grid-forming inverters 110 may operate as voltage sources. The grid-forming inverters 110 may have ability to set voltages in the grid GD and to maintain them. The grid-forming inverters 110 may generate and adjust voltages by themselves so that they may maintain the voltages and supply power to loads even in a state where they are separated from the grid GD.

Although the grid-forming inverters 110 do not provide physical inertia, it may provide virtual inertia or synthetic inertia to the grid GD. This is a technology of adjusting reactions of an inverter using controlling algorithms so as to make the inverter operate like a synchronous generator having traditional inertia.

A virtual inertia function is designed such that the grid-forming inverters 110 rapidly react to frequency changes of the grid GD. For example, if the frequencies of the grid GD decrease due to sudden increase of loads in the grid GD, the grid-forming inverters 110 may rapidly supply additional power to the grid GD to alleviate the frequency decline. If the loads in the grid GD are reduced on the contrary, the grid-forming inverters 110 may reduce the power supply to inhibit the frequency rise.

The virtual inertia of the grid-forming inverters 110 may serve as an important function in a situation where the proportion of traditional synchronous generators decreases and the proportion of renewable energy generators RG increases in a grid GD. The virtual inertia may assist to maintain stability of a grid GD and to manage changes in frequencies.

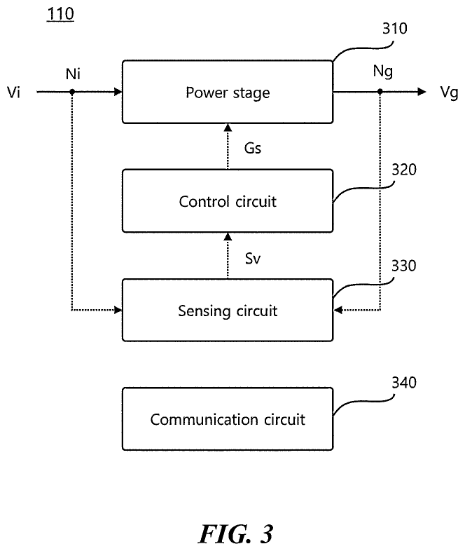

FIG. 3 is a configuration diagram of a grid-forming inverter according to an embodiment.

Referring to FIG. 3, a grid-forming inverter 110 may comprise a power stage 310, a control circuit 320, a sensing circuit 330, and a communication circuit 340.

The power stage 310 may convert power according to on/off control of switching devices and output converted power to a grid.

An input node Ni of the power stage 310 may be connected with renewable enery generators. For example, to the input node of the power stage 310, outputs of energy storage devices, photovoltaic power generating devices, etc. may be connected.

An output node Ng of the power stage 310 may be connected with the grid.

The power stage 310 may include multiple switching devices. On or off states of these switching devices may be determined by control signals Gs supplied from the control circuit 320.

The control signals Gs may be gate control signals for the switching devices. The gate control signals may be pulse width modulation (PWM) signals. Each of switching devices may be on in a time period where a PWM signal is at a high level and may be off in a time period where the PWM signal is at a low level.

The control circuit 320 may receive a sensing signal Sv from the sensing circuit 330 and generate a control signal Gs using such a sensing signal Sv. A sensing signal Sv may be a signal of sensing, for example, an input voltage Vi, an output voltage, an input current, an output current, a grid voltage Vg, or the like. An output voltage and a grid voltage Vg may have a same value or different values. The sensing circuit 330 may sense an output voltage and a grid voltage Vg separately; sense an output voltage and estimate a grid voltage Vg; or sense a grid voltage Vg and estimate an output voltage.

The communication circuit 340 may send and receive information with other circuits through analogue communication and/or digital communication. For example, the communication circuit 340 may receive a command value from a superior controller. The communication circuit 340 may receive an active power command value and/or reactive power command value from a superior controller and transmit the command value to the control circuit 320.

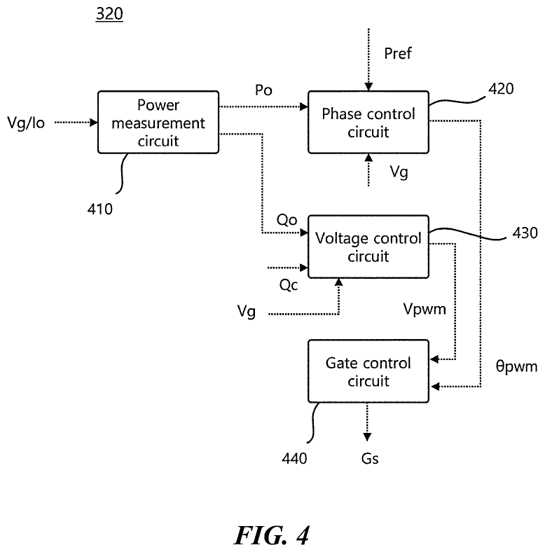

FIG. 4 is a configuration diagram of a control circuit according to an embodiment.

Referring to FIG. 4, the control circuit 320 may comprise a power measurement circuit 410, a phase control circuit 420, a voltage control circuit 430, and a gate control circuit 440.

The power measurement circuit 410 may receive an output voltage or a grid voltage Vg and an output current Io and measure reactive output power Qo and active output power Po. The power measurement circuit 410 is also referred to as a power meter.

The voltage control circuit 430 may receive reactive output power Qo and a reactive power command value Qc and to generate a voltage control value Vpwm.

The voltage control circuit 430 may calculate a reactive power reference using a reactive power droop gain formula. The voltage control circuit 430 may form a reactive power droop gain formula using a reactive power droop gain and a value corresponding to an X-intercept or to a Y-intercept and calculate a reactive power reference by substituting an output voltage or a grid voltage Vg into the reactive power droop gain formula. Alternatively, the voltage control circuit 430 may calculate a reactive power reference by adding up a value calculated by the reactive power droop gain formula and a reactive power command value Qc.

The voltage control circuit 430 may calculate a voltage control value Vpwm based on the reactive power reference. The voltage control circuit 430 may calculate a voltage control value Vpwm by applying a proportional integral (PI) control circuit to a difference between the reactive power reference and the reactive output power Qo.

The phase control circuit 420 may calculate a phase control value θpwm using a difference between an active power reference value Pref and an active output power value Po. The gate control circuit 440 may generate a control signal Gs for controlling the switching devices using PWM based on the voltage control value Vpwm and the phase control value θpwm.

Here, the active power reference value Pref and the active power command value may be the same. Hereinafter, descriptions are made by being focused on embodiments, in which the active power reference value and the active power command value are the same.

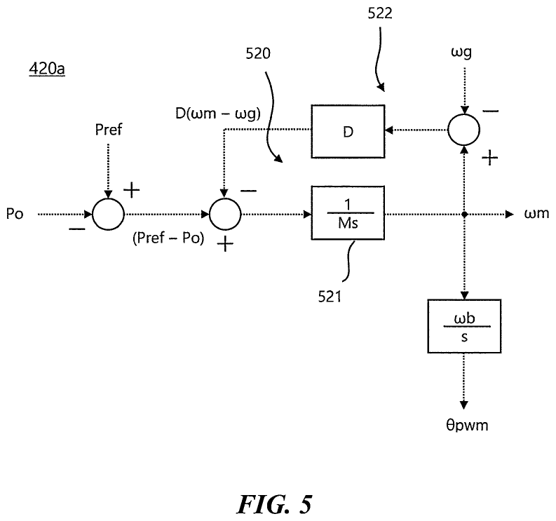

FIG. 5 is a diagram showing a first example of a phase control circuit according to an embodiment.

Referring to FIG. 5, a phase control circuit 420a may generate an angular velocity control value ωm using an inertia model 521 and calculate a phase control value θpwm by integrating the angular velocity control value ωm.

In order to further apply damping, the phase control circuit 420a may calculate, as a damping value, a value D (ωm−ωg) obtained by subtracting an angular velocity value of a grid voltage ωg from the angular velocity control value ωmand multiplying a result value by a damping coefficient D, and input the damping value into the inertia model 521 through a feedback loop. Here, the angular velocity value of a grid voltage ωg may be measured by a phase lock loop (PLL) circuit.

The phase control circuit 420a may include a virtual inertia model 520. The virtual inertia model 520 may include an inertia model 521 and a damping model 522.

The inertia model 521 may integrate the difference between the active power command value Pref and the active output power value Po of the power stage. Additionally, the inertia model 521 may integrate a value obtained by subtracting the value D (ωm−ωg), outputted from the damping model 522, from the difference between the active power command value Pref and the active output power value Po.

Also, the phase control circuit 420a may take a value outputted from the inertia model 521 as the angular velocity control value ωm and calculate the phase control value θpwm by multiplying the angular velocity control value ωm by a certain coefficient ωb and integrating a result value.

The damping model 522 may multiply a value obtained by subtracting the angular velocity value of a grid voltage ωg from the angular velocity control value ωm by the damping efficient D and negatively feed a result value back to the inertia model 521.

Along such a feedback loop, the phase control circuit 420a may supply a value obtained by subtracting the value D (ωm−ωg) from the difference (Pref−Po) between the active power command value Pref and the active output power value Po as an input for the inertia model 521.

By such a configuration, the phase control circuit 420a may apply both inertia M and damping D.

The inertia model 521 may calculate the angular velocity control value ωm or the phase control value θpwm by integrating the difference between the active power command value Pref and the active output power value Po of the power stage.

The damping model 522 may multiply a difference between the angular velocity control value ωm and the angular velocity value of a grid voltage ωg by the damping efficient D and negatively feed a result value back to the inertia model 521.

The inertia model 521 may calculate the angular velocity control value ωm: by obtaining a difference between the active power command value Pref and the active output power value Po of the power stage; obtaining a value by multiplying a difference between the angular velocity control value ωm and the angular velocity value ωg of grid power by the damping coefficient D; subtracting this value from the difference between the active power command value Pref and the active output power value Po of the power stage; dividing a result value by a predetermined inertia value M; and integrating a result value.

Such a grid-forming inverter may provide the grid with inertia M as in a response function of an output and an angular velocity described below. Here, ωo refers to an angular velocity of an output voltage and Po refers to output power value.

$$ω o ( s ) / Po ( s ) = - 1 / ( sM + D )$$

When observing the response function of the output power value Po with respect to the active power command value Pref, it can be noticed that a response speed of the output power Po for the active power command value Pref is slow.

$$Po ( s ) / Pref ( s ) = ωr * P max / ( Ms \hat{} 2 + Ds + ω r * P max )$$

$$P max = 3 Vo * Vg / Xl$$

Here, ωr refers to a rated angular velocity of grid power and Pmax refers to a maximum output power value of the grid-forming inverter, which may be calculated by dividing a value, obtained by multiplying three times a grid-forming output voltage Vo and a grid voltage Vg, by a grid-connected line reactance X1. The grid-connected line reactance X1 may be a reactance between an output of the grid-forming inverter and a grid-connected point. The Pmax may be determined by a value obtained by dividing three times a nominal voltage by the grid-connected line reactance X1 based on an assumption that the grid-forming output voltage Vo and the grid voltage Vg are similar to the nominal voltage.

It can be considered that an embodiment shown in FIG. 5 has a relatively slow response speed in terms that an output power for an active power command value of an inverter without including an inertia model has a form of a first transfer function with a very small time constant.

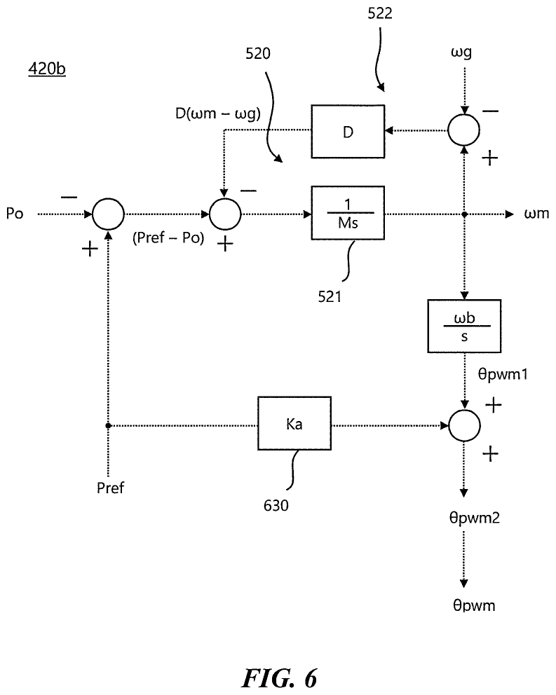

FIG. 6 is a diagram showing a second example of a phase control circuit according to an embodiment.

Referring to FIG. 6, a phase control circuit 420b may generate an angular velocity control value ωm using the inertia model 521 and calculate a phase control value θpwm by integrating the angular velocity control value ωm.

In order to further apply damping, the phase control circuit 420b may calculate, as a damping value, a value D (ωm−ωg) obtained by multiplying a value, obtained by subtracting an angular velocity value of a grid voltage ωg from an angular velocity control value ωm, by a damping coefficient D, and input the damping value into the inertia model 521 through a feedback loop. Here, the angular velocity value of a grid voltage ωg may be measured by a phase lock loop (PLL) circuit.

The phase control circuit 420b may include a virtual inertia model 520. The virtual inertia model 520 may include an inertia model 521 and a damping model 522.

The inertia model 521 may integrate a difference between the active power command value Pref and the active output power value Po of the power stage. Additionally, the inertia model 521 may integrate a value obtained by subtracting the value D (ωm−ωg), outputted from the damping model 522, from the difference between the active power command value Pref and the active output power value Po.

Also, the phase control circuit 420b may take a value outputted from the inertia model 521 as the angular velocity control value ωm and calculate the phase control value θpwm by multiplying the angular velocity control value ωm by a certain coefficient ωb and integrating a result value.

The damping model 522 may multiply a value obtained by subtracting the angular velocity value of a grid voltage ωg from the angular velocity control value ωm by the damping efficient D and negatively feed a result value back to the inertia model 521.

Along such a feedback loop, the phase control circuit 420b may supply a value obtained by subtracting the value D (ωm−ωg) from the difference (Pref-Po) between the active power command value Pref and the active output power value Po as an input for the inertia model 521.

By such a configuration, the phase control circuit 420b may apply both inertia M and damping D.

The phase control circuit 420b may calculate the angular velocity control value ωm using the virtual inertial model 520 and calculate a first phase control value θpwm1 by multiplying the angular velocity control value ωm by a certain coefficient ob and integrating a result value.

The phase control circuit 420b may calculate a second phase control value θpwm2 through feed-forward control that additionally reflects the active power command value Pref in the first phase control value θpwm1. The phase control circuit 420b may output the second phase control value θpwm2 as a phase control value θpwm.

The phase control circuit 420b may calculate the second phase control value θpwm2 by multiplying the active power command value Pref by a feed-forward gain Ka and adding up a result value to the first phase control value θpwm1.

When observing a response function of output power value Po for the active power command value Pref in such a control configuration, it can be noticed that two zeros are added, indicating that the response speed becomes more rapid compared to the response function in FIG. 5.

$$Po ( s ) / Pref ( s ) = ( Ka * P max * ( Ms \hat{} 2 + Ds ) + ω r * P max ) / Ms \hat{} 2 + Ds + ω r * P max )$$

Here, the feed-forward gain Ka may be determined in response to a reciprocal of the maximum output value Pmax of the power stage described with reference to FIG. 5.

$$Ka = 1 / P max$$

$$P max = 3 Vo * Vg / Xl$$

When the feed-forward gain Ka is determined as such, it can be verified that the quick responsiveness of the grid-forming inverter is improved as shown in the following equation.

$$Po ( s ) / Pref ( s ) \approx 1$$

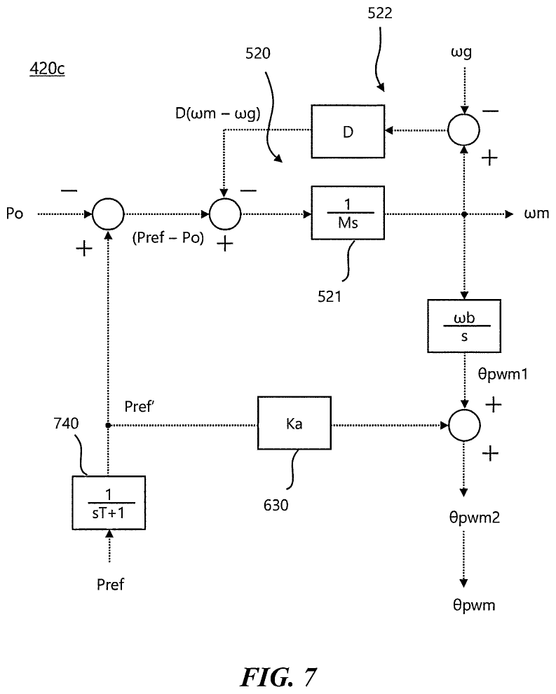

FIG. 7 is a diagram showing a third example of a phase control circuit according to an embodiment.

When comparing the example of FIG. 7 with the example of FIG. 6, in the example of FIG. 7, the active power command value Pref is not used as it is, but is used after applying the first transfer function 740.

The active power command value Pref may be used after applying the first transfer function 740. As an input for the virtual inertia model 520, a value obtained by subtracting the active output power value Po of the power stage from an active power command value Pref′, which has passed through the first transfer function 740 may be transferred.

A phase control circuit 420c may perform feed-forward control that additionally reflects the active power command value Pref', which has passed through the first transfer function 740, in a first phase control value θpwm1. The phase control circuit 420c may calculate a second phase control value θpwm2 by multiplying the active power command value Pref′, which has passed through the first transfer function 740, by a feed-forward gain Ka and adding up a result value to the first phase control value θpwm1.

The first transfer function 740 may impose a certain upper limit on acceleration of the response speed.

A bandwidth of the first transfer function 740, determined by a time constant T of the first transfer function 740, may be narrower than a bandwidth of a voltage controller.

The voltage controller, which may be included in the gate control circuit (440 in FIG. 4), may be a voltage controller disposed between the phase control value θpwm and an output of a PWM signal. The gate control circuit may include a voltage controller, which generates a PWM signal, and a current controller. The voltage controller may receive a voltage control value (Vpwm in FIG. 4) and the phase control value θpwm as inputs and generate a PWM signal. The first transfer function 740 may have a narrower bandwidth than the voltage controller. For example, the bandwidth of the first transfer function 740 may fall within a certain range of 1/10 of the bandwidth of the voltage controller.

Based on such a bandwidth of the first transfer function 740, a certain upper limit may be imposed on the acceleration of the response speed and the stability of a system may be enhanced.

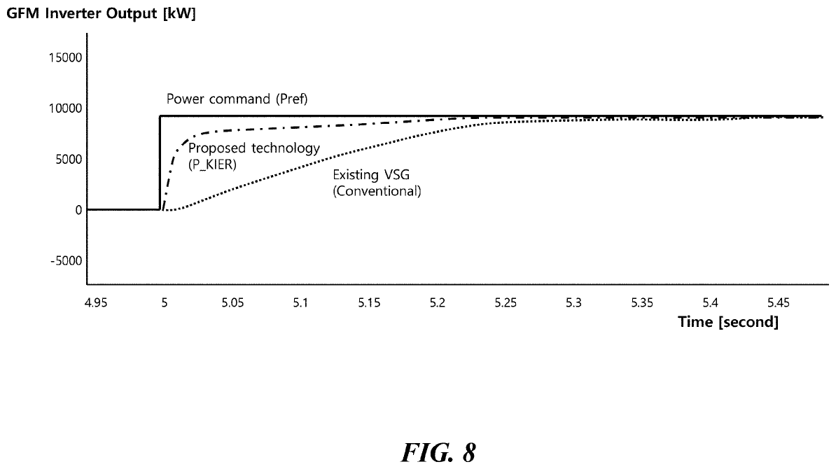

FIG. 8 is a diagram showing waveforms of output power in a simulation of a grid-forming inverter according to an embodiment.

Referring to FIG. 8, it can be verified that the grid-forming inverter according to an embodiment (see the curve for the proposed technology in FIG. 8) has an improved response speed compared with an inverter without feed-forward control (see the curve for the existing VSG in FIG. 8) and an output power of the grid-forming inverter according to an embodiment shows a waveform similar to a waveform of a power command in the form of a step.

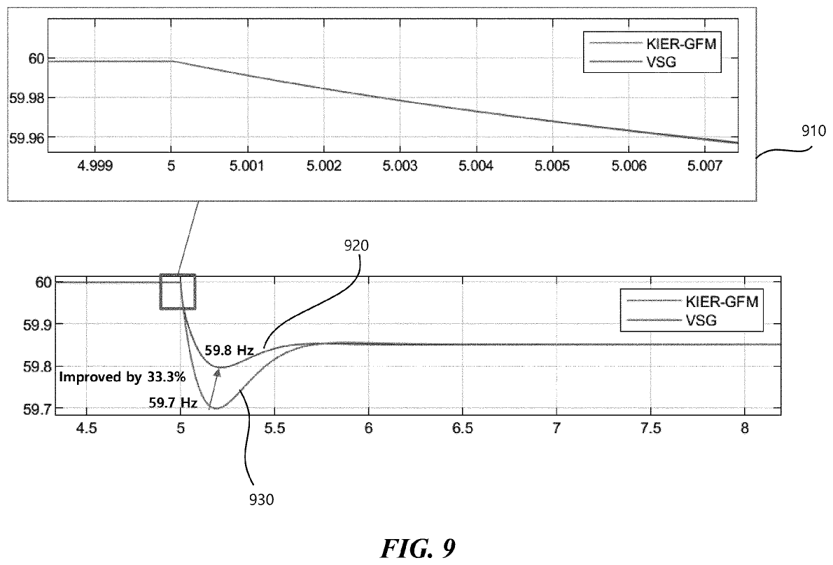

FIG. 9 is a diagram showing waveforms of frequencies in a simulation of a grid-forming inverter according to an embodiment.

Referring to FIG. 9, it can be verified that the grid-forming inverter according to an embodiment (see 920) has an improved frequency nadir compared with an inverter without feed-forward control (see 930).

Additionally, as shown in a waveform 910, which is an enlargement of a sudden change point in frequency, the grid-forming inverter according to an embodiment (see 920) has an inertial contribution to the grid (Rate of Change of Frequency: RoCoF) almost identical to that of an inverter without feed-forward control (see 930).

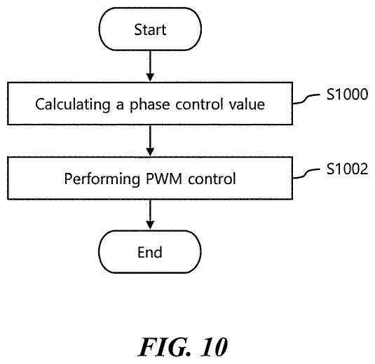

FIG. 10 is a flow diagram of a grid-forming inverter control method according to an embodiment.

Referring to FIG. 10, the grid-forming inverter may calculate a first phase control value using an inertia model that integrates a difference between an (active) power command value and an active output power value of the power stage and calculate a second phase control value through a feed-forward control that additionally reflects the (active) power command value in the first phase control value (S1000).

Here (in S1000), the grid-forming inverter may apply a first transfer function to the (active) power command value before performing the feed-forward control that reflects the (active) power command value in the first phase control value. The bandwidth of the first transfer function may be narrower than the bandwidth of a voltage controller disposed between the second phase control value and an output of a PWM signal.

The grid-forming inverter may calculate an angular velocity control value by subtracting the active output power value of the power stage and a damping value from the (active) power command value, dividing a result value by a predetermined inertia value, and integrating a result value; and calculate the first phase control value by multiplying the angular velocity control value by a certain coefficient and integrating a result value.

Subsequently, the grid-forming inverter may calculate the second phase control value by multiplying the (active) power command value by a feed-forward gain and adding up a result value to the first phase control value.

The grid-forming inverter may perform PWM control with respect to switching devices of the power stage according to the second phase control value (S1002).

As described above, the present disclosure may provide a technology for a grid-forming inverter contributing to the frequency stability of the grid. The present disclosure may also provide a technology for improving a slow responsiveness of a grid-forming inverter. The present disclosure may additionally provide a technology for improving a response speed of a grid-forming inverter controlled by a virtual synchronizer. Further, the present disclosure may provide a technology for improving a frequency nadir by rapid responses to power commands.

Since terms, such as “including,” “comprising,” and “having” mean that corresponding elements may exist unless they are specifically described to the contrary, it shall be construed that other elements can be additionally included, rather than that such elements are excluded. All technical, scientific, or other terms are used consistently with the meanings as understood by a person skilled in the art unless defined to the contrary. Common terms as found in dictionaries should be interpreted in the context of the related technical writings, rather than overly ideally or impractically, unless the present disclosure expressly defines them so.

Although a preferred embodiment of the present disclosure has been described for illustrative purposes, those skilled in the art will appreciate that various modifications, additions, and substitutions are possible without departing from the scope and spirit of the embodiment as disclosed in the accompanying claims. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

What is claimed is:

1. A grid-forming inverter comprising:
a power stage configured to convert electric power according to on/off controls of switching devices and to output converted electric power to a grid; and
a control circuit configured to calculate a first phase control value using an inertia model that integrates a difference between a power command value and an active output power value of the power stage, to calculate a second phase control value through feed-forward control that additionally reflects the power command value in the first phase control value, and to control the switching devices using pulse width modulation (PWM) according to the second phase control value.

2. The grid-forming inverter of claim 1, wherein the control circuit applies a first transfer function to the power command value before performing feed-forward control that additionally reflects the power command value in the first phase control value.

3. The grid-forming inverter of claim 2, wherein a bandwidth of the first transfer function is narrower than a bandwidth of a voltage controller disposed between the second phase control value and an output of a PWM signal.

4. The grid-forming inverter of claim 3, wherein the bandwidth of the first transfer function falls within a certain range of 1/10 of the bandwidth of the voltage controller.

5. The grid-forming inverter of claim 1, wherein the control circuit calculates an angular velocity control value by subtracting the active output power value of the power stage and a damping value from the power command value, dividing a result value by a predetermined inertial value, and integrating a result value; and calculate the first phase control value by multiplying the angular control value by a certain coefficient and integrating a result value.

6. The grid-forming inverter of claim 5, wherein the control circuit calculates the damping value by multiplying a difference between the angular velocity control value and an angular velocity value of a gride voltage by a damping coefficient.

7. The grid-forming inverter of claim 6, wherein the angular velocity value of the grid voltage is measured by a phase lock loop (PLL) circuit.

8. The grid-forming inverter of claim 1, wherein the control circuit calculates the second phase control value by multiplying the power command value by a feed-forward gain and adding up a result value to the first phase control value.

9. The grid-forming inverter of claim 8, wherein the feed-forward gain is determined in response to a reciprocal of the maximum output of the power stage.

10. The grid-forming inverter of claim 8, wherein a value of the maximum output is determined by a value obtained by dividing three times a nominal voltage by a reactance.

11. A method for controlling a power stage in which a grid-forming inverter converts power according to on/off controls of switching devices and outputs converted power to a grid, the method comprising operations or steps of:
calculating a first phase control value using an inertia model that integrate a difference between a power command value and an active output power value of the power stage and calculating a second phase control value through feed-forward control that additionally reflects the power command value in the first phase control value; and
performing pulse width modulation (PWM) control with respect to the switching devices based on the second phase control value.

12. The method of claim 11, wherein, in the operation or step of calculating the second phase control value, a first transfer function is applied to the power command value, and subsequently, the feed-forward control that additionally reflects the power command value in the first phase control value is performed.

13. The method of claim 12, wherein a bandwidth of the first transfer function is narrower than a bandwidth of a voltage controller disposed between the second phase control value and an output of a PWM signal.

14. The method of claim 11, wherein, in the operation or step of calculating the second phase control value, an angular velocity control value is calculated by subtracting the active output power value of the power stage and a damping value from the power command value, dividing a result value by a predetermined inertia value, and integrating a result value; and the first phase control value is calculated by multiplying the angular velocity control value by a certain coefficient and integrating a result value.

15. The method of claim 11, wherein, in the operation or step of calculating the second phase control value, the second phase control value is calculated by multiplying the power command value by a feed-forward gain and adding up a result value to the first phase control value.
